(19) United States
(12) Patent Application Publication
(10) Pub. No.: US 2010/0150331 A1
(43) Pub. Date: Jun. 17, 2010

(54) SYSTEM AND METHOD FOR TELEPHONY SIMULTANEOUS TRANSLATION TELECONFERENCE

(76) Inventors: Asaf Gitelis, Moshav Bnei Atarot (IL); Reuben Berman, Beer Sheva (IL)

Correspondence Address: Asaf Gitelis, P.O.Box 182, Moshav Bnei Atarot, 60991, omitted

(21) Appl. No.: 12/334,553

(22) Filed: Dec. 15, 2008

(51) Int. Cl. H04M 3/42

(52) U.S. Cl. 379/202.01

(57) ABSTRACT

In one aspect, the present invention is directed to a system for carrying out a simultaneous translation teleconference, the system comprising: a teleconferencing room; a scheduler, for managing a schedule of a human simultaneous translator and of the teleconferencing room; and a user interface between a user and the scheduler, for ordering a teleconference between the human translator and participants in the teleconferencing room; thereby allowing carrying out a simultaneous translation teleconference between the participants and the human translator. The user interface may be an Internet menu, an audio menu, a video menu and so on. According to one embodiment of the invention, the user interface is embodied as a code dialed with a requested telephone number, thereby informing the system of the telephone company thereof to identify a request for scheduling a teleconferencing room for carrying out an STT. Preferably, the code is associated with at least one language.

### FIELD OF THE INVENTION

The present invention relates to the field of teleconferencing. More particularly, the invention relates to a simultaneous translation teleconference system and method.

### BACKGROUND OF THE INVENTION

Attempts to automate simultaneous translation of speech have been made for years. For example, U.S. Pat. No. 4,654,798, from 1984, discloses a sentence-forming apparatus that formsdelivers a plurality of semantically equivalent sentences simultaneously in a plurality of languages by a conversational system. The apparatus includes a semantic dictionary memory which stores a plurality of indices in a first language, a plurality of words in the first language semantically in coordination respectively with the indexes and grammatical information relating to the respective words, and first language syntax dictionary memory and second language syntax dictionary memory which stores information concerning grammatical syntax and words in the corresponding language.

However, as of today, the results are not satisfying, and accordingly, automated simultaneous translation systems are not common.

U.S. Pat. No. 7,069,222 from 2006 discloses a consecutive, simultaneous translation method and system for use in the courtroom and other settings to permit accurate and discrete translation from a source language to a target language. In its most basic form, the method involves providing a translator with a record/playback device, so that the translator can record words spoken in a source language, allow time for (for example) an objection and ruling, and play back the recorded words in the source language and translate those into the target language in a simultaneous manner. Other features include earphones for the translator to afford greater discretion and accuracy, slow playback capabilities, and other enhancements.

Nevertheless, this solution is limited to courtrooms, and as such, its applicability to general use is limited.

It is an object of the present invention to provide a system and method for simultaneous translation in telephony.

Other objects and advantages of the invention will become apparent as the description proceeds.

### SUMMARY OF THE INVENTION

The following embodiments and aspects thereof are described and illustrated in conjunction with systems, tools methods, and so forth, which are meant to be merely illustrative, not limiting in scope.

In one aspect, the present invention is directed to a system for carrying out a simultaneous translation teleconference, the system comprising:
a teleconferencing room;
a scheduler, for managing a schedule of a human simultaneous translator and of the teleconferencing room; and
a user interface between a user and the scheduler, for ordering a teleconference between the human translator and participants in the teleconferencing room;
   thereby allowing carrying out a simultaneous translation teleconference between the participants and the human translator.

The user interface may be an Internet menu, an audio menu, a textual menu, and so on. According to one embodiment of the invention, a human operator intermediates between a user and the scheduler.

According to one embodiment of the invention, the user interface is embodied as a code dialed with a requested telephone number, thereby informing the system of the telephone company thereof to identify a request for scheduling a teleconferencing room for carrying out an STT. Preferably, the code is associated with at least one language.

Preferably, the scheduler is a computerized system running an application software and maintaining a database.

The terminal for holding the teleconference may be a computer, an audio input and output facility, a video input and output facility, a textual input and output facility, and so on.

The teleconference may be carried out as a scheduled teleconference, as a casual teleconference, and so on.

In another embodiment of the invention, the present invention is directed to a method for carrying out a simultaneous translation teleconference, the method comprising the steps of:
scheduling a teleconference between a plurality of participants and a human translator;
at the scheduled time thereof, allocating a teleconferencing room for the teleconference; and
allowing the participants and the human translator to connect to the teleconferencing room.

In yet another aspect, the present invention is directed to a method for carrying out a translation service, the method comprising the steps of:
redirecting a short message addressed to an addressee to a human translator;
providing by the human translator a textual translation of the short message; and
forwarding the translated message to the addressee.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 schematically illustrates a teleconference service, according to the prior art.

FIG. 2 schematically illustrates a simultaneous translation teleconference, according to one embodiment of the invention.

FIG. 3 schematically illustrates a cellular telephone initiating a casual STT, according to one embodiment of the invention.

FIG. 4 illustrates a system for scheduling and ordering an STT, according to one embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of brevity.

The term teleconference refers herein as to a conference held between a plurality of participants via telecommunication lines.

In a teleconference, each participant uses a terminal for two purposes: inputting the information to be posted to the other participants, and displaying the information sent by the other participants. A terminal supports sending and displaying at least one of the following signals: audio, video and textual information.

An online chat is actually a teleconference that employs the Internet as communication lines.

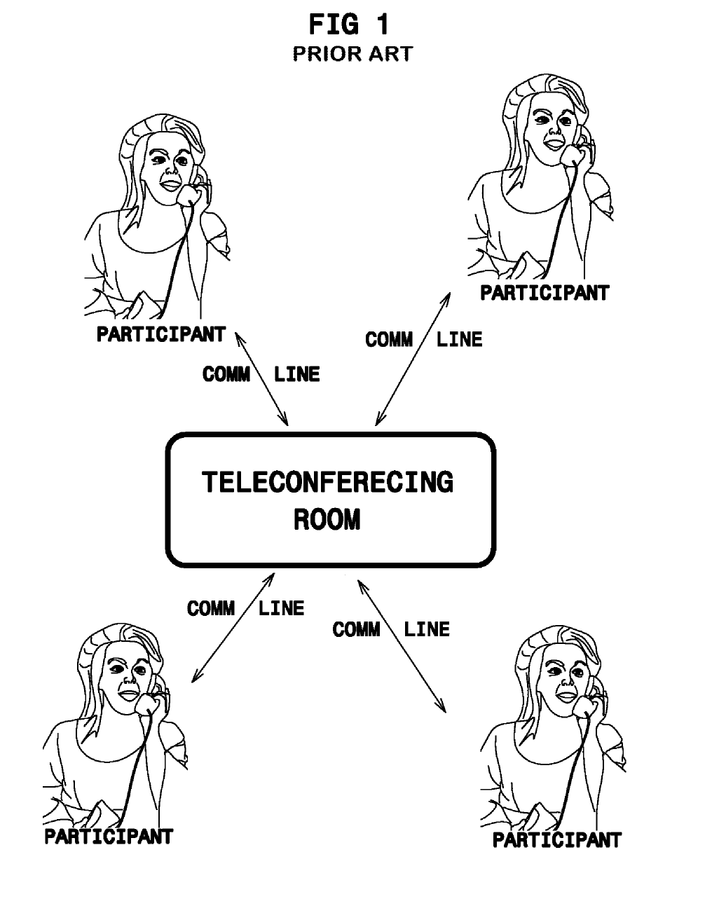

FIG. 1 schematically illustrates a teleconference service, according to the prior art.

The illustration shows a plurality of individuals carrying out a conversation via a teleconferencing room. A teleconferencing room is a session in which a plurality of participants communicates with each other such that any message sent by one participant is displayed on the terminals of all other participants.

The term Simultaneous Translation Teleconference (STT) refers herein as to a teleconference held between a plurality of participants and at least one human simultaneous translator that translates from one language to another and preferably vice versa.

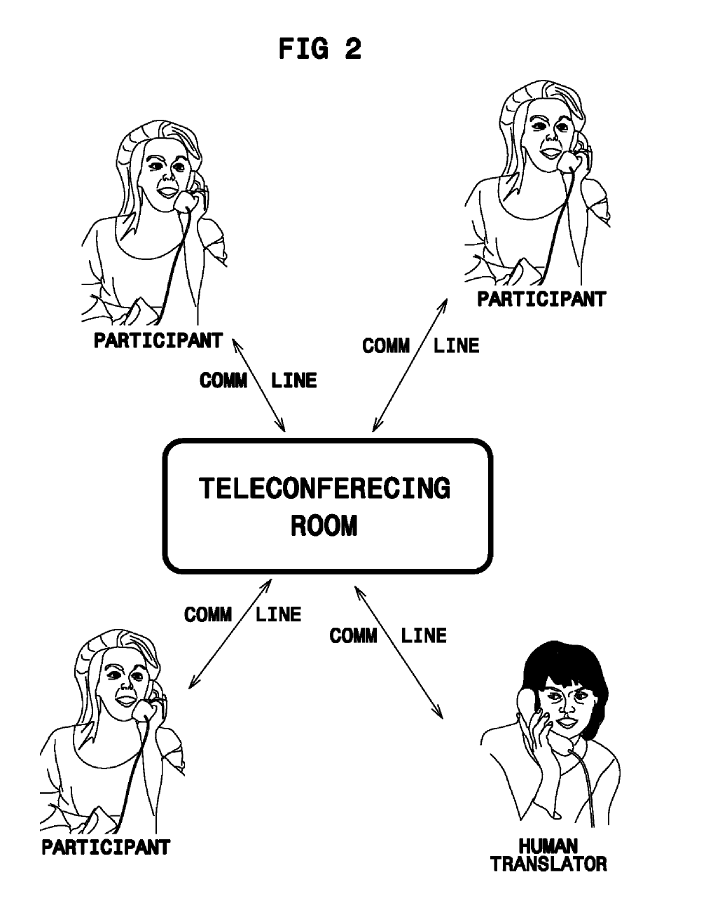

FIG. 2 schematically illustrates a simultaneous translation teleconference, according to one embodiment of the invention.

The difference between the prior art as illustrated in FIG. 1 and the present invention as illustrated in FIG. 2 is that in FIG. 2, one of the participants is a human simultaneous translator, who translates the sounded speech from a first language into a second language. Thus, at least one of the participants speaks the first language, while at least one of the other participants speaks the second language.

The translation can be carried out in audio signals, video signals, and textual expression. A terminal may be a telephone handset, a video screen, a teletype (means for typing and displaying text), a personal computer, which may use the other means such as audio, video and textual information, and so on.

For example, in an STT carried out using personal computers as terminals, the participants can hear and see each other, and even use text in the conversation. The human translator may pronounce the translated phrases, and even type them. Furthermore, a plurality of human translators can participate in an STT, each translating from one language to the other, such as one from English to Chinese, and the other one from Chinese to English. This way the translation is more effective, especially if the translation is expressed in typed text.

### Scheduled STT

Presently, scheduled teleconferencing is well known in business affairs, especially when the participants reside overseas. According to one embodiment of the invention, a managing program allocates a teleconferencing room at a certain time. At this time, each participant calls to a telephone number associated with the teleconferencing room, and enters into the teleconference upon providing a password. The human translators participating in the teleconference are familiar with the languages and even with the specific terms of the conference, such as medical terms, financial terms, and so on.

### Casual STT

A tourist in a foreign country that does not speak the local language may be helpless in an emergency case, such as when he needs a doctor, an ambulance, and so on.

According to one embodiment of the invention, the tourist may use the services of a human simultaneous translator.

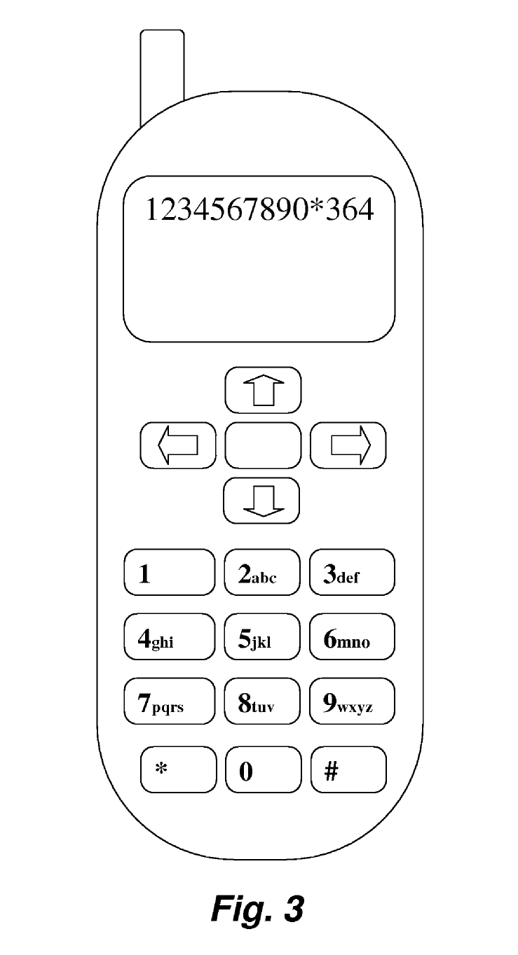

FIG. 3 schematically illustrates a cellular telephone initiating a casual STT, according to one embodiment of the invention.

For example, the tourist dials the telephone number of an emergency service. In order to signal to the telephone company that he requires the presence of a human translator in the conversation, he adds to the dialed number a code, such as *372, which is interoperated by the telephone company system as an order to perform the teleconference with the participation of a human translator with knowledge of the local language and the foreign language associated with the number 372.

Preferably, the code is based on the association of the telephone dial keys with letters. For example, 364 can be associated with ENG since 3 is associated with E (the same key on the telephone keypad), 6 is associated with N, and 4 is associated with G. The system of the telephone company may inform the user to hold on while a required human translator becomes available.

### Initiating a Scheduled STT

A simultaneous translation teleconference can be ordered by an Internet menu, an audio menu, a textual menu, and even by a human operator.

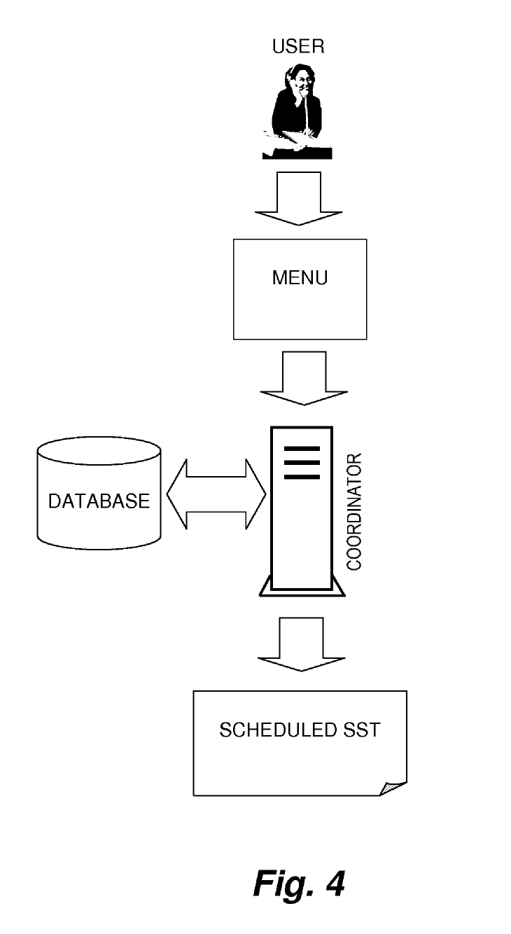

FIG. 4 illustrates a system for scheduling and ordering an STT, according to one embodiment of the invention.

The system comprises an input facility, for inputting an order for STT, such as the requested time of the STT, duration of the STT, languages, participation of any translator(s) or specific translator(s), familiarity of the human translator(s) with certain terms, and so on.

After the parameters are provided, the system checks in the database the availability of human translator(s) of these languages at the requested time, and so on. After the STT has been scheduled, the system informs the user that ordered the STT how to enter the STT, such as the teleconference telephone numbers (e.g., a local telephone in every country), conference ID, password, etc.

The input facility may be embodied as an Internet page, but also as an audio menu, i.e., a user interface in which the questions/options are presented by playing a recording, and the user provides answers by clicking on the keys on his touch-tone telephone dial.

“Dual-tone multi-frequency (DTMF) signaling is used for telephone signaling over the line in the voice-frequency band to the call-switching center. The version of DTMF used for telephone tone dialing is known by the trademarked term Touch-Tone, and is standardized by ITU-T Recommendation Q.23. Other multi-frequency systems are used for signaling internal to the telephone network.” (From Wikipedia)

A textual menu may be embodied as a Web page, a computer program, as a software program executed on a cellular telephone, and so on.

According to one embodiment of the invention, the charge for an STT is dictated by the number of participants, their geographical location, hourly rate of the human translator(s), duration of the STT, and so forth. The clearing may be carried out by the telephone company thereof or any other service provider involved in the STT.

According to one embodiment of the invention, the human translators registered in the system are rated by the users (“popularity rate”). The hourly rate of a human translator may be affected by his popularity status. The bill of the clearing company may comprise a list of the STTs carried out, details of the STT, charge per hour, total charge, and so on.

The database may store information about the hour a translator is available. According to one embodiment of the invention, a human translator may update his available hours in the database via an Internet menu, and so on.

According to one embodiment of the invention, the simultaneous translation service is applied also on SMS (Short Messaging Service) messages. An SMS to be translated is directed to a human translator. The translated text is sent to the addressee along with or instead of the original text. In this case, no teleconference is needed.

According to one embodiment of the invention, an SMS message is marked as a message to be translated by adding a code at the end of the dialed number, as explained hereinabove.

According to another embodiment of the invention, a menu is embedded in the functionality of a cellular telephone. The menu allows the user to define the language of the short message, and the language of the translation. Of course, these are merely examples, and the same functionality may be achieved in other forms.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for carrying out a simultaneous translation teleconference, the system comprising:
a teleconferencing room;
a scheduler, for managing a schedule of (a) a human simultaneous translator and (b) of said teleconferencing room; and
a user interface between a user and said scheduler, for ordering a teleconference between said human translator and a plurality of participants in said teleconferencing room;
thereby allowing carrying out a simultaneous translation teleconference between said plurality of participants and said human translator.

2. A system according to claim 1, wherein said user interface is an Internet menu.

3. A system according to claim 1, wherein said user interface is an audio menu.

4. A system according to claim 1, wherein said user interface is a textual menu.

5. A system according to claim 1, wherein said user interface is an infrastructure for allowing a human operator to interact with said scheduler and said user.

6. A system according to claim 1, wherein said user interface comprises a code dialed with a requested telephone number.

7. A system according to claim 1, wherein said code is associated with at least one language.

8. A system according to claim 1, wherein said scheduler is a computerized system running an application software and maintaining a database.

9. A system according to claim 1, wherein each of said plurality of participants uses a terminal for holding said teleconference.

10. A system according to claim 9, wherein said terminal is a computer.

11. A system according to claim 9, wherein said terminal comprises audio input and output facilities.

12. A system according to claim 9, wherein said terminal comprises video input and output facilities.

13. A system according to claim 9, wherein said terminal comprises textual input and output facilities.

14. A system according to claim 1, wherein said teleconference is a scheduled teleconference.

15. A system according to claim 1, wherein said teleconference is a casual teleconference.

16. A method for carrying out a simultaneous translation teleconference, the method comprising the steps of:
scheduling a teleconference between a plurality of participants and a human translator;
at the scheduled time thereof, allocating a teleconferencing room for said teleconference; and
allowing said participants and said human translator to connect to said teleconferencing room.

17. A method for carrying out a translation service, the method comprising the steps of:
redirecting a short message addressed to an addressee to a human translator;
providing by said human translator a textual translation of said short message; and
forwarding said translated message to said addressee.
